(19) United States
(12) Patent Application Publication
(10) Pub. No.: US 2001/0037018 A1
(43) Pub. Date: Nov. 1, 2001

(54) PROCESS FOR THE MANUFACTURE OF BIODEGRADABLE STARCH ESTERS

(76) Inventors: ROLF KAKUSCHKE, WOHNSITZ (DE); INNO RAPTHEL, HALLE (DE); HARTMUT STOYE, HALLE (DE); GUNTER SCHMOZ, HALLE (DE)

Correspondence Address: HORST M KASPER, 13 FOREST DRIVE, WARREN, NJ, 070595832

(21) Appl. No.: 09/242,851

(22) Filed: Feb. 22, 1999

Related U.S. Application Data
(63) Continuation of application No. PCT/DE97/01705, filed on Aug. 11, 1997.

(30) Foreign Application Priority Data
Aug. 20, 1996 (DE) 196 33 474.8

(51) Int. Cl. C08B 31/02; C08B 35/02; C08B 33/06

(52) U.S. Cl. 536/107; 536/108; 536/109; 536/110

(57) ABSTRACT

The invention covers a process to manufacture biodegradable starch esters which can be processed into extrudates, formed parts and sheeting. The starch is activated with a carboxylic acid/carboxylic anhydride mixture through partial swelling and the onsetting esterification reaction at simultaneous conversion of the water entrained in the starch and partially esterified with a carboxylic anhydride up to the desired degree of substitution with progressing swelling and disintegration.

This invention covers a process to manufacture biodegradable strach esters which can be processed into extrudates, formed parts and sheeting as well as to cast films and deep drawing dies by means of appropriate plasticizers.

A process to manufacture cellulose and starch esters, and more specifically acetyl esters, has been known for some time (P. Schützenberger, C. R. hebd. Séances Acad. Sci. 61 (1865), 485-486; P. Schützenberger, C. R. hebd. Séances Acad. Sci. 68 (1869), 814-818).

The common process of making cellulose acetates by mineral-acid catalytic esterification of acetic acid/acetic anhydride mixtures according to EP 0 146 936 cannot be easily transferred to the manufacture of starch esters since starches in a mineral acidic agent are subject to rapid hydrolytic decomposition.

Hence, neither the acidic catalytic esterification in an aqueous solution as described in EP 0 204 353 nor the mineral acid addition staggered over time as described in U.S. Pat. No. 205,863 are suited to produce thermoplastic materials of sufficient strength and good workability.

By contrast, slow esterification of starches in amine solvents such as pyridine according to U.S. Pat. No. 2,627,516 allows for an almost complete esterification of the hydroxyl groups of the starch without any essential hydrolytic chain degradation even in the presence of strongly acidic reaction components according to EP 0 342 599. However, a problem here is the treatment of the esters since even slightest amine residues will result in considerable odour problems and health impact during further processing stages. Also, it is extremely difficult to recover the solvent.

For the above reasons, a number of tests were carried out to esterify starches without amine solvents or catalysts in non-aqueous solutions.

Satisfactory results were only achieved with activated starches whereby the intramolecular and intermolecular hydrogen bridge bonds were largely destroyed through swelling reactions in the acqueous phase and subsequent water extraction (J. Muetgeert et al., Stärke 12 (10) 1958, 303-308), whereas native starches are esterified after a very long reaction time only (J. Tranquair J. Soc. Chem. Ind. 28 (1909), 288 ff or H. T. Clarke; H. B. Gillespie J. Amer. Chem. Soc. 54 (1932), 2083-88).

A clearly more straightforward process for slow alkaline catalytic esterification of starches is reported by MARK and MEHLTRETTER (Stärke 24, (3), pp. 73-76 (1972). The starch catalyst ratio determined through systematic trial and error is found again in several later publications.

The disadvantage of this process, however, is that a considerable excess of acid anhydride is required to achieve short reaction times, and hence a defined adjustment of a desired degree of substitution through shortening the reaction time is hardly reproducible.

The esterification processes described in DE 4 114 185 are an improvement based on the process described by MARK and MEHLTRETTER in U.S. Pat. No. 3,795,670, but here, too, considerable excess of acid anhydride is required, and the degree of subsitution can only be adjusted via the reaction time.

The process described in DE 4 223 471 allows a good reproducibility of the desired degree of substitution and a considerable reduction of the acid anhydride excess. The alkaline-activated starch is flocculated from the aqueous phase, dried and esterified in a separate reaction step to yield translucent to yellowish starch esters of very good mechanical properties.

The disadvantage of this process is that it is a costly and energy-intensive two-stage process with intermediate flocculation and drying.

The use of anhydrous acetic acid/acetic anhydride mixtures as acetylating agents is known as well. For example, C. A. Burkhard (Rayon Text. Month., 23 (1942), 340 ff) was able to make a starch triacetate after a ca. 40-hour reaction at return temperature. Hence, the adequately efficient esterification of native, non-activated starches in acetic acid/carboxylic acid anhydride mixtures is only possible in the presence of adequate acidic or amine/alkaline catalysts.

Esterification of activated starches is much faster and more efficient. A fairly homogeneous distribution of substituents can be achieved at degrees of substitution as low as DS≈2. However, the considerable costs required for starch activation are in contrast to commercialisation.

It is the intention of this invention to avoid the disadvantages of the aforementioned state of engineering and to propose an economic process to make starch esters with defined adjustable degrees of substitution at a largely homogeneous distribution of substituents.

This intention is met through claims 1 through 9 whereby claims 2 through 6 are preferred embodiments of the invention.

Surprisingly, it was found that native or slightly chemically modified starches with degrees of substitution between 0.001 and 1 can be activated with aliphatic monocarboxylic acids of a chain length of C₁ to C₁₂ whereby the water from the starch or starch derivates is converted with carboxylic anhydrides in a parallel quick reaction so that there is only a very weak esterification reaction at the starch matrix besides the conversion of moisture, and the carboxylic anhydride volume necessary for a proper esterification reaction is only metered with progressing swelling and destructuring of the starch.

A similar activation only with carboxylic anhydride was not feasible. The starch esters made according to the process of the invention are white, pourable powders which almost completely dissolve in solvents such as chloroform, acetone, ethylmethyl ketone, ethyl acetate, and a definite turbidity only occurs at degrees of substitution smaller than DS≈2.0. At degrees of substitution between 1.8 and 2.7, the starch esters made according to the invention can be processed into biodegradable, translucent, brilliant formed parts, sheeting or thermoformed products with good mechanical properties with or without the use of plasticizers.

### EXAMPLE 1

800 g of wheat starch (moisture content 13%)

600 g of glacial acetic acid

800 g of acetic anhydride

are heated to ca. 120 C. in a 10-liter agitator reactor with a reflux condenser and maintained at this temperature for 30 minutes. Then, 1,100 g of acetic anhydride and 1,400 g of glacial acetic acid are added over ca. 60 minutes and then maintained at ca. 125 C. for 6 hrs. The reaction mixture is cooled down to 90 C. and diluted with 3 kg of glacial acetic acid, and flocculated in water. The flocculated wheat starch diacetate is washed three to five times with water, and dried.

Yield: 1,000 g

DS: 2.30

### EXAMPLE 2

1,380 g of maize starch (moisture content 12.6%)

500 g of acetic acid

1,100 g of acetic anhydride

are heated to about 50 C. in a 10-liter agitator reactor with reflux condenser. Then, 1,700 g of acetic anhydride and 1,500 g of glacial acetic acid are quickly added and maintained at ca. 125 C. at the reflux for 3 hrs. After cooling to 90 C., the reaction mixture is diluted with 3 kg of glacial acetic acid, and flocculated in water. The flocculated maize starch diacetate is washed three to five times with water, and dried.

Yield: 1,850 g

DS: 2.30

### EXAMPLE 3

1,380 g of high-amylose maize starch (moisture content 12%)-70% amylose

300 g of glacial acetic acid

950 g of acetic anhydride

are heated to 120 C. in a 10-liter agitator reactor with reflux condenser and maintained at this temperature for 30 minutes. Then, 1,900 g of acetic anhydride and 1,000 g of glacial acetic acid are added over ca. 15 mins. and kept at the reflux at ca. 125 C. for 5 hrs. After cooling to 90 C., the reaction mixture is diluted with 2 kg of glacial acetic acid, and flocculated in water. The flocculated high-amylose maize starch diacetate is washed three to fives times with water, and dried.

Yield: 1,900 g

DS: 2.31

### EXAMPLE 4

1,380 g of high-amylose maize starch (moisture content 12%)-85% amylose

500 g of glacial acetic acid

1,000 g of acetic anhydride

are heated to about 50 C. in a 10-liter agitator reactor with reflux condenser. Then, 1,900 g of acetic anhydride and 1,000 g of glacial acetic acid are added over ca. 30 mins, and kept at ca. 125 C. at the reflux for 7 hrs. After cooling to 90 C., the reaction mixture is diluted with 2 kg of glacial acetic acid, and flocculated in water. The flocculated high-amylose maize starch diacetate is washed three to fives times with water, and dried.

Yield: 1,900 g

DS: 2.30

### EXAMPLE 5

750 g of potato starch (moisture content 18%)

1,000 g of glacial acetic acid

1,000 g of acetic anhydride

are heated to about 120 C. in a 10-liter agitator reactor and maintained at this temperature for 15 mins. Then, 400 g of acetic anhydride are quickly added, and the reaction mixture is maintained at the reflux at about 128 C. for 1 hour. After adding a mixture of 300 g of acetic anhydride and 2,500 g of glacial acetic acid, the reaction mixture is maintained at the reflux at ca. 123 C. for 5 hours. After cooling to 90 C., the reaction mixture is diluted with 2.5 kg of glacial acetic acid, and flocculated in water. The flocculated potato starch diacetate is washed three to five times with water, and dried.

Yield: 850 g

DS: 1.8

### EXAMPLE 6

1,380 g of high-amylose pea starch (moisture content 13%)-80% amylose

750 g of glacial acetic acid

1,050 g of acetic anhydride

are heated to about 120 C. in a 10-liter agitator reactor and maintained at this temperature for 60 minutes. Then, 1,000 g of acetic anhydride are quickly added, and the reaction mixture is maintained at the reflux at about 128 C. for 2 hours. After adding a mixture of 1,100 g of acetic anhydride and 2,000 g of acetic acid, the reaction mixture is maintained at the reflux at ca. 125 C. for 8 hours. After cooling to 90 C., the reaction mixture is diluted with 3 kg of glacial acetic acid and flocculated in water. The flocculated pea starch acetate is washed three to fives times with water, and dried.

Yield: 1,950 g

DS: 2.6

### EXAMPLE 7

1,380 g of maize starch (moisture content 12.6%)

300 g of glacial acetic acid

500 g of acetic anhydride

are heated to about 120 C. in a 10-liter agitator reactor with reflux condenser. Then, 3,200 g of acetic anhydride are added uniformly over 120 minutes whereby the temperature rises to ca. 130 C. Then, 1,500 g of glacial acetic acid are added as quickly as possible, and the reaction mixture is kept at the reflux for 3 hours. After cooling to 90 C., the reaction mixture is diluted with 3 kg of glacial acetic acid, and flocculated in water. The flocculated maize starch triacetate is washed three to five times with water, and dried.

Yield: 2,080 g

DS: 2.92

### EXAMPLE 8

800 g of high-amylose maize starch (moisture content 12%)-70% amylose

3,000 g of glacial acetic acid

1,200 g of acetic anhydride

are heated to about 120 C. in a 10-liter agitator reactor with reflux condenser and maintained at this temperature for 60 minutes. Then, 400 g of acetic anhydride are added and kept at the reflux at ca. 123 C. for 4 hours. After cooling to 90 C., the reaction mixture is flocculated in water. The flocculated high-amylose maize starch diacetate is washed three to five times with water, and dried.

Yield: 1,100 g

DS: 2.35

### EXAMPLE 9

900 g of hydroxypropylated maize starch (moisture content 12%)-DS≈0.07

250 g of glacial acetic acid

650 g of acetic anhydride

are heated to about 120 C. in a 10-liter agitator reactor and maintained at this temperature for 30 minutes. Then, 1,200 g of oenanthic anhydride are quickly added, and after heating to about 135 C., 750 g of acetic anhydride are added over ca. 60 minutes. After another 60 minutes reaction time, 1,500 g of glacial acetic acid are added and stirred at about 130 C. for four hours. After cooling to 90 C., the reaction mixture is diluted with 2 kg of glacial acetic acid, and flocculated in water. The flocculated maize starch diester is washed three to five times with water, and dried.

Yield: 1,500 g

Total DS: 2.30

### EXAMPLE 10

800 g of oxidated maize starch (moisture content 12%)-0.65% carboxyl

650 g of propionic acid

600 g of acetic anhydride

are heated to about 130 C. in a 10-liter agitator reactor with reflux condenser and maintained at this temperature for 15 minutes. Then, 900 g of lauric anhydride are quickly added and stirred for 60 minutes after heating to about 135 C. Then, 800 g of acetic anhydride are added over 120 minutes. After a reaction time of 60 minutes, 1,500 g of glacial acetic acid are added and stirred at about 130 C. for 120 minutes. After cooling to 90 C., the reaction mixture is diluted with 2 kg of glacial acetic acid, and flocculated in water. The resulting maize starch diester suspension is centrifugated twice, washed with water, and stripped with steam at about 95 C. for 15 minutes. Drying takes place after the steam-stripped product has been water washed once again.

Yield: 1,200 g

Total DS: 2.30

1. A process to manufacture biodegradable starch esters, characterized in that the starch a) is activated through partial swelling and an onsetting esterification reaction at simultaneous conversion of the water entrained in the starch with a carboxylic acid/carboxylic acid anhydride mixture, b) is partially esterified with progressing swelling and destructuring with a carboxylic acid anhydride up to the desired degree of substitution.

2. The process according to claim 1, characterized in that the carboxylic acid/carboxylic acid anhydride mixture employed in step a) consists of 15 to 450%, preferably 20-100% carboxylic acid, relative to the starch volume employed, as well as of 0.4-3 equivalents, preferably 0.5-1.5 equivalent carboxylic acid anhydride, relative to the water entrained in the reaction mixture.

3. The process according to the claims 1 and 2, characterized in that step 1 b) is initiated after a reaction time of 1-100 minutes, preferably 5 to 60 minutes, by adding 0.5 to 1.5 equivalents, preferably 0.8 to 1.3 equivalents carboxylic acid anhydride relative to the desired degree of substitution.

4. The process according to the claims 1-3, characterized in that step b) is continued for 30-720 minutes, preferably 120 to 600 minutes, until achievement of a complete disintegration and the desired degree of substitution of the partially esterified starch, wherein an additional 0% to 500% carboxylic acid, relative to the starch volume employed, are added.

5. The process according to the claims 1-4, characterized in that the reaction is performed in a temperature range between 50° C.-180° C., preferably between 75° C.-145° C.

6. The process according to the claims 1-5, characterized in that the reaction is performed in a single-pot process without isolation of intermediate products.

7. The process according to the claims 1-6, characterized in that both native starches such as maize starch, wheat starch, potato starch, rice starch, pea starch, wax maize starch, high-amylose maize starch, pea starch, tapioca starch or potato starches as well as their derivatives such as hydroxy ethylated, hydroxy propylated, acetalated, phosphorylated, sulfated, oxidated, carboxy alkylated, benzylated, nitrated allyl starches, xenthate starches, and carbamyl starches with degrees of substitution of between 0.001-1, preferably 0.1-0.5 in a naturally moist or predried state are used as starch components.

8. The process according to the claims 1-7, characterized in that the anhydrides of aliphatic carboxylic acid with the chain lengths C₂ to C₂₂, preferably C₂ to C₁₂, or the cyclic anhydrides of the maleic acid, the malonic acid, the succinic acid, the glutaric acid as well as their derivatives or mixtures of said carboxylic acid anhydrides are used as acid anhydride components.

9. The process according to the claims 1-8, characterized in that aliphatic monocarboxylic acids with chain lengths of C₁ to C₁₂, preferably C₂ to C₅, are used as carboxylic acids.
